(19) United States
(12) Patent Application Publication
(10) Pub. No.: US 2016/0092789 A1
(43) Pub. Date: Mar. 31, 2016

(54) Category Oversampling for Imbalanced Machine Learning

(71) Applicant: International Business Machines Corporation, Armonk, NY (US)

(72) Inventors: Noel C. Codella, Yorktown Heights, NY (US); Gang ` Hua, Yorktown Heights, NY (US); John R. Smith, New York, NY (US)

(21) Appl. No.: 14/500,023

(22) Filed: Sep. 29, 2014

(51) Int. Cl. G06N 99/00

(52) U.S. Cl. CPC G06N 99/005

(57) ABSTRACT

Methods, systems, and computer program products for category oversampling for imbalanced machine learning are provided herein. A method includes identifying an anchor data point in a given class of data points underrepresented among multiple classes in a data set of multiple data points, wherein each data point represent a vector; determining a number of data points in the given class that neighbor the anchor data point, wherein the number comprises two or more; applying a weight to (i) each of the number of data points to create a number of weighted neighboring data points, and (ii) the anchor data point to create a weighted anchor data point, wherein the sum of all weights is equal to one; performing a vector summation by summing the number of weighted neighboring data points and the weighted anchor data point; and generating a synthetic data point based on said vector summation.

### FIELD OF THE INVENTION

Embodiments of the invention generally relate to information technology, and, more particularly, to machine learning technology.

### BACKGROUND

Imbalanced data sets are prevalent in many practices, and are commonly found in instances such as, for example, when training data are presented to a machine learning system and the number of positive examples is far fewer than the number of negative examples. Such imbalance, however, can have significant negative impacts on training classifiers. One existing balancing approach includes oversampling by synthetic minority oversampling techniques. However, such an approach is limited and encompasses an insufficient amount and/or variety of data.

Accordingly, a need exists for techniques for utilizing information from multiple neighboring data points simultaneously to represent the variety exhibited in a local neighborhood of data.

### SUMMARY

In one aspect of the present invention, techniques for category oversampling for imbalanced machine learning are provided. An exemplary computer-implemented method can include steps of identifying an anchor data point in a given class of data points, wherein the given class of data points is underrepresented among multiple classes in a data set of multiple data points, wherein each of the multiple data points represents a vector; determining a given number of data points in the given class that neighbor the anchor data point, wherein the given number comprises two or more; applying a weight to (i) each of the given number of data points in the given class that neighbor the anchor data point to create a given number of weighted neighboring data points, and (ii) the anchor data point to create a weighted anchor data point, wherein the sum of all applied weights is equal to one; performing a vector summation by summing the given number of weighted neighboring data points and the weighted anchor data point; and generating a synthetic data point to be associated with the given class of data points, wherein the synthetic data point represents the result of said vector summation.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a graph diagram illustrating an existing oversampling approach;

FIG. 2 is a diagram illustrating an example embodiment of the invention;

FIG. 3 is a diagram illustrating system architecture, according to an example embodiment of the invention;

FIG. 4 is a flow diagram illustrating techniques according to an embodiment of the invention; and

FIG. 5 is a system diagram of an exemplary computer system on which at least one embodiment of the invention can be implemented.

### DETAILED DESCRIPTION

As described herein, an aspect of the present invention includes techniques for category oversampling for imbalanced machine learning. As used herein, oversampling refers to adjusting the class distribution of multiple classes (or categories) represented in a given data set. Moreover, oversampling generally includes selecting data points from a minority class (that is, a class that is underrepresented in the given data set as compared to one or more other classes) to serve as the basis for the generation of additional and/or synthetic data points in an attempt to balance the class distribution in the given data set.

FIG. 1 is a graph diagram illustrating an existing oversampling approach, wherein the original data point is represented as data point 102. Also, the nearest neighbors (of original data point 102) are represented as data points 110, 112, 114, 116 and 118, and the synthetically generated data are represented as data points 120, 122, 124, 126 and 128. Per the existing approach illustrated in FIG. 1, each synthetic data point (that is, data points 120, 122, 124, 126 and 128) must lie on a line between the original data point 102 and a single neighboring data point of the original data point. Accordingly, such an approach is disadvantageous because the synthetic datum is generated from only two points positioned in what may potentially be a high-dimensional data set.

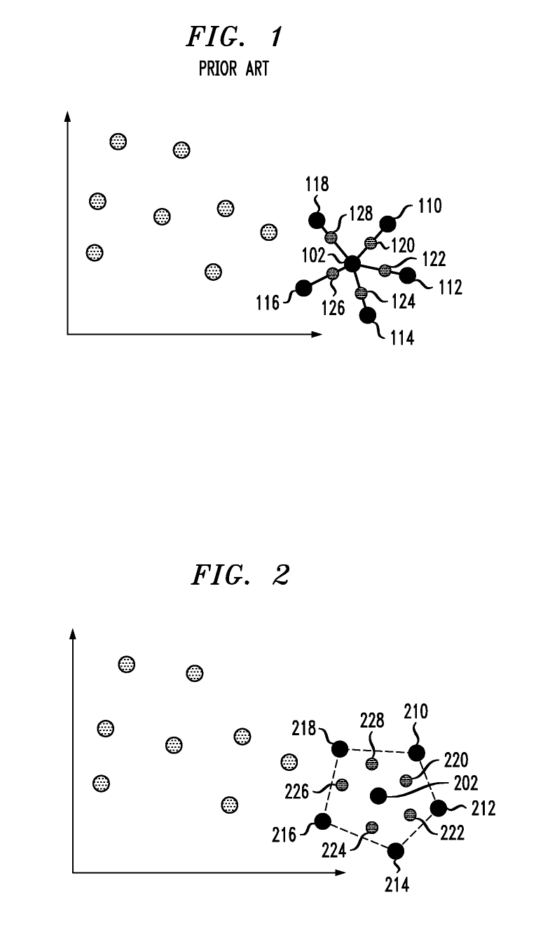

FIG. 2 is a diagram illustrating an example embodiment of the invention. By way of illustration, FIG. 2 depicts an example embodiment of the invention wherein the class is assumed to exhibit a local manifold structure in the feature space. As used herein, a class is defined as the collection of data examples represented as n-dimensional feature vectors in an n-dimensional feature space (wherein n varies according to the features used). Additionally, a local manifold structure refers to the general statistical topological pattern to which the data locally adhere. Under such circumstances, an example embodiment of the invention can include taking combinations of multiple local neighbors to create a synthetic data point. By using more than one local neighbor, additional data points are thereby incorporated, creating greater variety of the resultant synthetic data point than is possible with the above-noted existing approaches. As such, at least one embodiment of the invention includes yielding a broader distribution of new synthetic data points that can provide additional generalization ability for a classifier that is trained on the data, thereby improving performance.

The above-noted example embodiment of the invention is visualized in FIG. 2, wherein data point 202 represents the original data point (also referred to herein as the anchor data point), data points 210, 212, 214, 216 and 218 represent the nearest neighbors (of original data point 202), and data points 220, 222, 224, 226 and 228 represent the generated synthetic (that is, new) data points. As illustrated in FIG. 2, all of the generated synthetic data points (that is, data points 220, 222, 224, 226 and 228) lie or subsist within the dotted lines representing a local n-dimensional volume defined by the k neighboring data points used for construction (here, data points 210, 212, 214, 216 and 218).

As illustrated, FIG. 2 depicts an output graph of data-related analysis. It is to be appreciated by one skilled in the art that one or more embodiments of the invention can be applied to and/or implemented with any graph of scattered data.

Also, in one or more embodiments of the invention, the original data point (such as 202, in FIG. 2) is weighted by a fixed value to ensure that the distance between the original data point and a new synthetic data point is not so large as to represent an impossible data point. This helps to improve performance of the resulting classifier in one or more conditions.

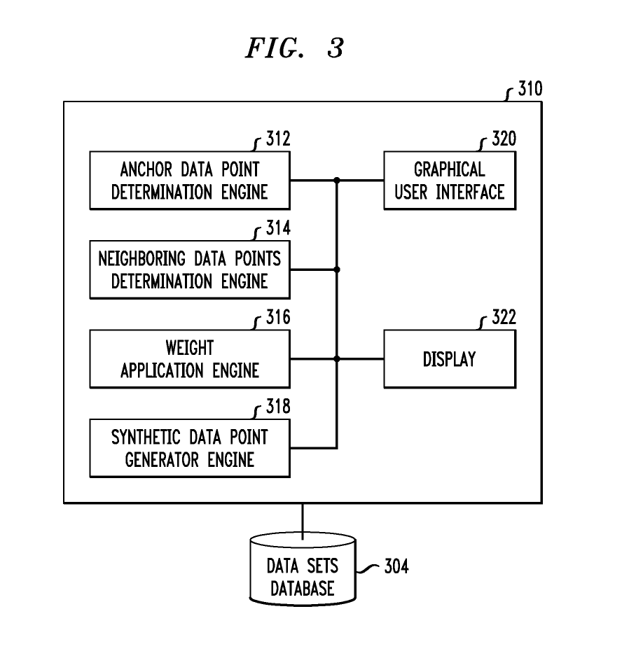

FIG. 3 is a diagram illustrating system architecture, according to an example embodiment of the present invention. By way of illustration, FIG. 3 depicts a synthetic data point generation system 310, which receives input from a data sets database 304, as further described herein. Additionally, the synthetic data point generation system 310 includes an anchor data point determination engine 312, a neighboring data points determination engine 314, a weight application engine 316, a synthetic data point generator engine 318, a graphical user interface 320 and a display 322. As further detailed herein, engines 312, 314, 316 and 318 process multiple data points to generate a synthetic data point based on the input provided by data sets database 304. The generated synthetic data point is then transmitted, along with the original (or anchor) data point (and one or more additional synthetic data points, if additional iterations are carried out), to the graphical user interface 320 and the display 322 for presentation and/or potential manipulation by a user.

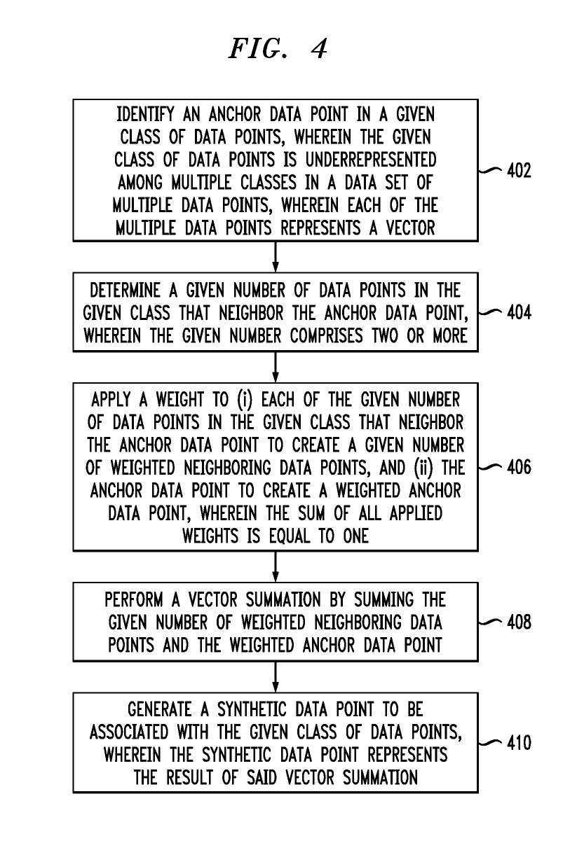

FIG. 4 is a flow diagram illustrating techniques according to an embodiment of the present invention. Step 402 includes identifying an anchor data point in a given class of data points, wherein the given class of data points is underrepresented among multiple classes in a data set of multiple data points, wherein each of the multiple data points represents a vector. Identifying the anchor data point can include, for example, randomly selecting the anchor data point.

Step 404 includes determining a given number of data points in the given class that neighbor the anchor data point, wherein the given number comprises two or more. In at least one embodiment of the invention, this determining step includes implementation of a k-nearest neighbors algorithm.

Step 406 includes applying a weight to (i) each of the given number of data points in the given class that neighbor the anchor data point to create a given number of weighted neighboring data points, and (ii) the anchor data point to create a weighted anchor data point, wherein the sum of all applied weights is equal to one. The weight applied to each of the neighboring data points can be based, for example, on proximity to the anchor point. Also, the weight applied to each of the neighboring data points can be randomly selected. The weight applied to the anchor data point can be set, for example, as equal to the number of data points in the given class that neighbor the anchor data point (for instance, the k-nearest neighbors of the anchor data point).

Step 408 includes performing a vector summation by summing the given number of weighted neighboring data points and the weighted anchor data point. Step 410 includes generating a synthetic data point to be associated with the given class of data points, wherein the synthetic data point represents the result of said vector summation.

Additionally, the techniques depicted in FIG. 4 can also include repeating all of the steps of FIG. 4 for a given number of iterations. The given number of iterations can be identified by a user and/or can be determined as the number of iterations required to establish a representation balance among the multiple classes in a data set.

Also, in at least one embodiment of the invention, the given class of data points includes a set of data points represented as n-dimensional feature vectors in an n-dimensional feature space. Further, in such an embodiment, the generated synthetic data point subsists within the n-dimensional feature space.

As also detailed herein, identifying the anchor data point can be executed by an anchor data point determination engine of a synthetic data point generation computing device. Additionally, determining the given number of data points in the given class that neighbor the anchor data point can be executed by a neighboring data points determination engine of a synthetic data point generation computing device. Also, applying a weight to each of the given number of data points in the given class that neighbor the anchor data point, as well as applying a weight to the anchor data point can be executed by a weight application engine of a synthetic data point generation computing device. Further, performing the vector summation, as well as generating the synthetic data point to be associated with the given class of data points can be executed by a synthetic data point generator engine of a synthetic data point generation computing device.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

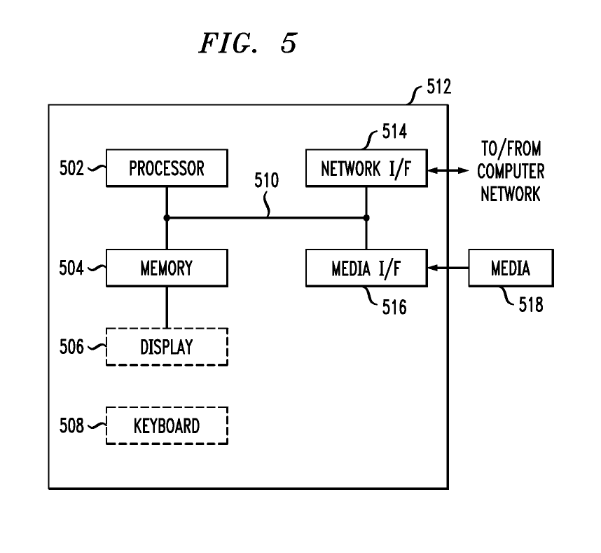

Additionally, an aspect of the present invention can make use of software running on a general purpose computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, incorporating multiple neighboring points in the generation of synthetic data points, while weighting the center point by a fixed value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising the following steps:
identifying an anchor data point in a given class of data points, wherein the given class of data points is underrepresented among multiple classes in a data set of multiple data points, wherein each of the multiple data points represents a vector;
determining a given number of data points in the given class that neighbor the anchor data point, wherein the given number comprises two or more;
applying a weight to (i) each of the given number of data points in the given class that neighbor the anchor data point to create a given number of weighted neighboring data points, and (ii) the anchor data point to create a weighted anchor data point, wherein the sum of all applied weights is equal to one;
performing a vector summation by summing the given number of weighted neighboring data points and the weighted anchor data point; and
generating a synthetic data point to be associated with the given class of data points, wherein the synthetic data point represents the result of said vector summation;
wherein at least one of the steps is carried out by a computing device.

2. The method of claim 1, comprising:
repeating all of said steps for a given number of iterations.

3. The method of claim 2, wherein the given number of iterations is identified by a user.

4. The method of claim 2, wherein the given number of iterations comprises the number of iterations required to establish a representation balance among the multiple classes in the data set.

5. The method of claim 1, wherein the given class of data points comprises a set of data points represented as n-dimensional feature vectors in an n-dimensional feature space.

6. The method of claim 5, wherein the generated synthetic data point subsists within the n-dimensional feature space.

7. The method of claim 1, wherein said determining comprises implementation of a k-nearest neighbors algorithm.

8. The method of claim 1, wherein said identifying the anchor data point comprises randomly selecting the anchor data point.

9. The method of claim 1, wherein said weight applied to each of the neighboring data points is based on proximity to the anchor point.

10. The method of claim 1, wherein said weight applied to each of the neighboring data points is randomly selected.

11. The method of claim 1, wherein said weight applied to the anchor data point is equal to the number of data points in the given class that neighbor the anchor data point.

12. The method of claim 11, wherein said weight applied to the anchor data point is equal to the k-nearest neighbors of the anchor data point.

13. The method of claim 1, wherein said identifying the anchor data point is executed by an anchor data point determination engine of a synthetic data point generation computing device.

14. The method of claim 1, wherein said determining the given number of data points in the given class that neighbor the anchor data point is executed by a neighboring data points determination engine of a synthetic data point generation computing device.

15. The method of claim 1, wherein said applying a weight to each of the given number of data points in the given class that neighbor the anchor data point is executed by a weight application engine of a synthetic data point generation computing device.

16. The method of claim 1, wherein said applying a weight to the anchor data point is executed by a weight application engine of a synthetic data point generation computing device.

17. The method of claim 1, wherein said performing the vector summation is executed by a synthetic data point generator engine of a synthetic data point generation computing device.

18. The method of claim 1, wherein said generating the synthetic data point is executed by a synthetic data point generator engine of a synthetic data point generation computing device.

19. A computer program product, the computer program product comprising a computer readable storage medium having program instructions embodied therewith, the program instructions executable by a computing device to cause the computing device to:
identify an anchor data point in a given class of data points, wherein the given class of data points is underrepresented among multiple classes in a data set of multiple data points, wherein each of the multiple data points represents a vector;
determine a given number of data points in the given class that neighbor the anchor data point, wherein the given number comprises two or more;
apply a weight to (i) each of the given number of data points in the given class that neighbor the anchor data point to create a given number of weighted neighboring data points, and (ii) the anchor data point to create a weighted anchor data point, wherein the sum of all applied weights is equal to one;
perform a vector summation by summing the given number of weighted neighboring data points and the weighted anchor data point; and
generate a synthetic data point to be associated with the given class of data points, wherein the synthetic data point represents the result of said vector summation.

20. A system comprising:
a memory; and
at least one processor coupled to the memory and configured for:
identifying an anchor data point in a given class of data points, wherein the given class of data points is underrepresented among multiple classes in a data set of multiple data points, wherein each of the multiple data points represents a vector;
determining a given number of data points in the given class that neighbor the anchor data point, wherein the given number comprises two or more;
applying a weight to (i) each of the given number of data points in the given class that neighbor the anchor data point to create a given number of weighted neighboring data points, and (ii) the anchor data point to create a weighted anchor data point, wherein the sum of all applied weights is equal to one;
performing a vector summation by summing the given number of weighted neighboring data points and the weighted anchor data point; and
generating a synthetic data point to be associated with the given class of data points, wherein the synthetic data point represents the result of said vector summation.
